(19) United States
(12) Patent Application Publication
(10) Pub. No.: US 2016/0333602 A1
(43) Pub. Date: Nov. 17, 2016

(54) PET BARRIER

(71) Applicant: Doskocil Manufacturing Company, Inc., Arlington, TX (US)

(72) Inventor: David Veness, Fort Worth, TX (US)

(21) Appl. No.: 14/983,886

(22) Filed: Dec. 30, 2015

Related U.S. Application Data
(60) Provisional application No. 62/160,259, filed on May 12, 2015.

(51) Int. Cl. E04H 17/18; E04H 17/16; A01K 3/00

(52) U.S. Cl. CPC E04H 17/18; A01K 3/00; E04H 17/161

(57) ABSTRACT

A pet barrier is basically provided that includes a plurality of telescoping tubes, a plurality of bars and at least one locking device. The telescoping tubes are configured to be installed in a vehicle. The telescoping tubes include a first tube and a second tube. The second tube is sized and configured to be inserted into an inner cavity of the first tube. The second tube includes a noise damping cap installed thereon to separate the second tube from an inner wall of the first tube. The plurality of bars extends transverse to the telescoping tubes. The locking device is configured to secure the plurality of bars to the telescoping tubes.

### CROSS-REFERENCE TO RELATED APPLICATIONS

This application claims priority to Provisional Application Ser. No. 62/160,259 filed May 12, 2015, the contents of which are hereby incorporated by reference herein.

### BACKGROUND

1. Field of the Invention

This invention generally relates to a pet barrier. More specifically, the present invention relates to a pet barrier having telescoping tubes secured to a plurality of bars by a locking device.

2. Background Information

Conventional pet barriers can be installed into vehicles to aid occupancy safety when carrying loads or pets in the rear area of a vehicle. Conventional pet barriers are generally constructed of metal or other rigid materials and can be fabricated or assembled with mesh bars. Conventional pet barriers can act as a barrier between the rear area and passenger area of the vehicle to contain a pet within a particular area of the vehicle for the safety of the pet and for the passengers. For example, a pet barrier can act as a method of restraining an animal or a load from entering into the passenger area either in normal use, or more importantly, in the event of vehicle collision. Pet barriers can include a plurality of bars or wire grids that are constructed with noise damping features so that the pet barrier does not produce unwanted noise during road travel. Recently, pet barriers are constructed to be adjustably fit inside a vehicle without the need for tools.

### SUMMARY

Generally, the present disclosure is directed to various features of a pet barrier. In one feature, a pet barrier is provided having a plurality of telescoping tubes secured to a plurality of bars extending transverse to the telescoping tubes by a locking device.

In view of the state of the known technology and in accordance with a first aspect of the present disclosure, a pet barrier is provided that comprises a plurality of telescoping tubes, a plurality of bars and at least one locking device. The telescoping tubes are configured to be disposed in a vehicle. The telescoping tubes include a first tube and a second tube. The second tube is sized and configured to be inserted into an inner cavity of the first tube. The second tube includes a noise damping cap disposed thereon to separate the second tube from an inner wall of the first tube. The plurality of bars extends transverse to the telescoping tubes. The locking device is configured to secure the plurality of bars to the telescoping tubes.

Also other objects, features, aspects and advantages of the disclosed pet barrier will become apparent to those skilled in the art from the following detailed description, which, taken in conjunction with the annexed drawings, discloses two embodiments of the pet barrier.

### BRIEF DESCRIPTION OF THE DRAWINGS

Referring now to the attached drawings which form a part of this original disclosure:

FIG. 1 is an elevational view of a vehicle with a pet barrier installed in a rear area, in accordance with a first illustrated embodiment;

FIG. 2 is a perspective view of the pet barrier illustrated in FIG. 1;

FIG. 3 is an exploded perspective view of the pet barrier illustrated in FIGS. 1 to 2;

FIG. 4 is an enlarged perspective view of a portion of the pet barrier in FIGS. 1 to 3 showing the attachment of the first tube and the second tube;

FIG. 5 is an enlarged perspective view of a portion of the pet barrier in FIGS. 1 to 4 with a section of the first tube cut away to show the noise damping cap installed on an end of the second tube;

FIG. 6 is an exploded elevational view of the plurality of bars of the pet barrier in FIGS. 1 to 5;

FIG. 7 is an enlarged perspective view of a portion of the pet barrier in FIGS. 1 to 6 with the knob member of the locking device exploded from the hub member;

FIG. 8 is a perspective view of a pet barrier in accordance with a second illustrated embodiment;

FIG. 9 is an exploded perspective view of the pet barrier illustrated in FIG. 8;

FIG. 10 is an enlarged perspective view of a portion of the pet barrier illustrated in FIGS. 8 to 9 with a portion of the first tube cut away to show the noise damping cap installed on the second tube;

FIG. 11 is an enlarged perspective view in section of a portion of the pet barrier illustrated in FIGS. 8 to 10 showing the attachment of the first and second tubes; and

FIG. 12 is an enlarged perspective view of a portion of the pet barrier illustrated in FIGS. 8 to 11 with a portion of the locking device broken away to show the attachment of the wire grid to the locking device.

### DETAILED DESCRIPTION OF EMBODIMENTS

Selected embodiments will now be explained with reference to the drawings. It will be apparent to those skilled in the pet products field from this disclosure that the following descriptions of the embodiments are provided for illustration only and not for the purpose of limiting the invention as defined by the appended claims and their equivalents.

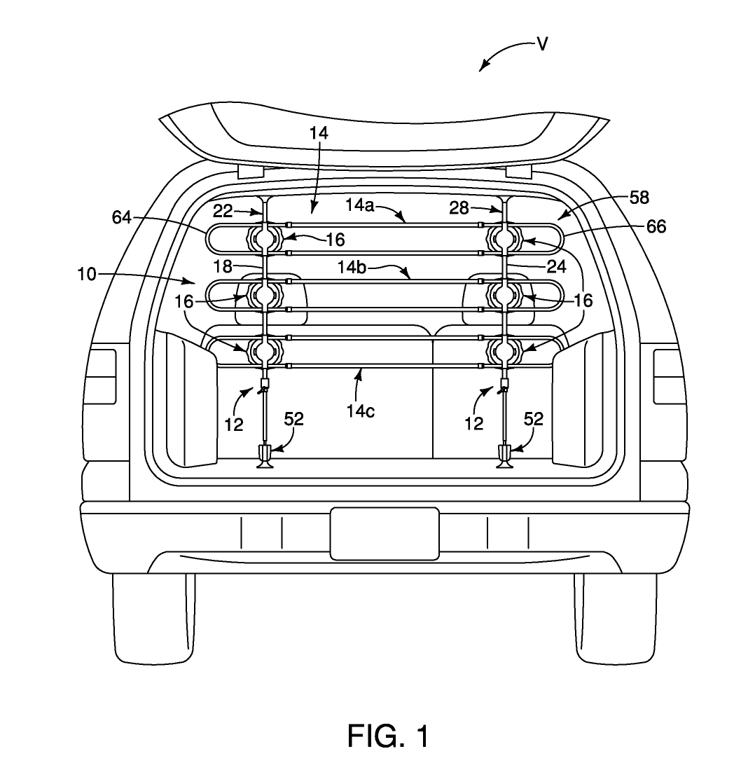

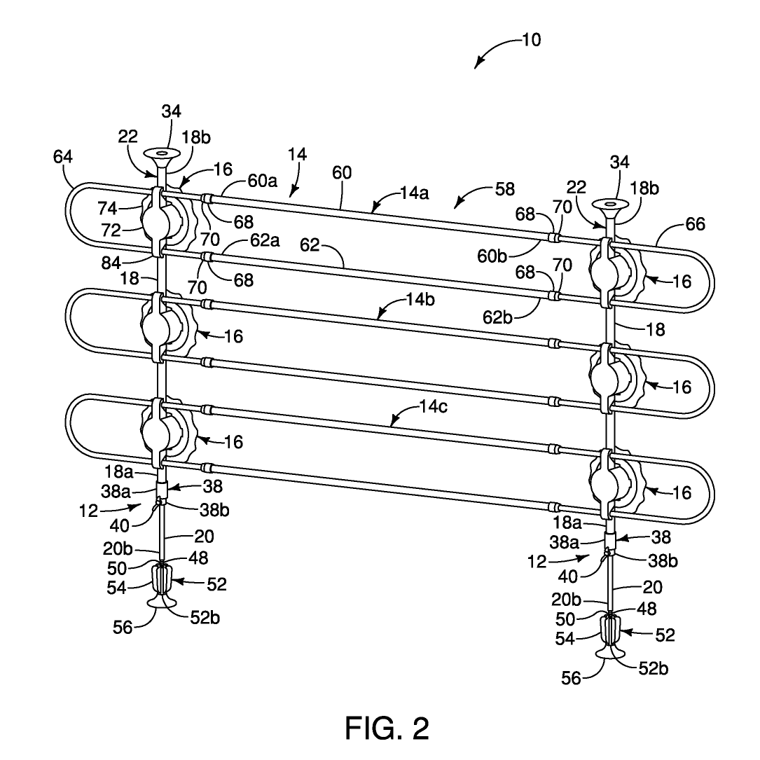

Referring initially to FIGS. 1 and 2, a pet barrier 10 is illustrated in accordance with a first embodiment. The pet barrier 10 is configured to be installed in a vehicle V to partition an inner space of the vehicle V into a pet or rear containing area and a pet or front restricted area. The pet barrier 10 can also be operatively situated in the inner space of the vehicle V between the pet containing area and a vehicle door (e.g., a rear hatch) to restrict the pet within the pet containing area when a rider opens or closes the vehicle door. In the illustrated embodiment, the pet barrier 10 is designed such that a partitioning area (e.g., the height and the width) of the pet barrier 10 is user adjustable so that the pet barrier 10 may be installed in vehicles of varying sizes. Furthermore, the pet barrier 10 is designed for easy assembly so that it may be installed within the vehicle V without the use of tools. To reduce unwanted noise during travel, the pet barrier 10 includes a number of noise damping features operatively arranged in the composite components of the pet barrier 10.

As shown in FIGS. 1 and 2, the pet barrier 10 basically comprises a plurality of telescoping tubes 12, a plurality of bars 14 and at least one locking device 16. In the first illustrated embodiment, the telescoping tubes 12 are configured to be installed in the vehicle V and serve as the support structure for the pet barrier 10. The telescoping tubes 12 and the plurality of bars 14 are made of a rigid material, such as metal or plastic or any other suitable material. As the height of the pet barrier 10 is user adjustable, the telescoping tubes 12 are designed to be user adjustable to vary the height of the pet barrier 10, as desired. In this capacity, each of the telescoping tubes 12 include a first tube 18 and a second tube 20. Together, the first and second tubes 18 and 20 comprise a support tube 22 for the pet barrier 10. The support tube 22 of each of the telescoping tubes 12 is a rigid member in the illustrated embodiment. It will be apparent to those skilled in the art from this disclosure that the pet barrier 10 may be configured to include additional or fewer support tubes as needed or desired. As each of the support tubes are identical, only one support tube 22, and its component first and second tubes 18 and 20, will be discussed in detail herein.

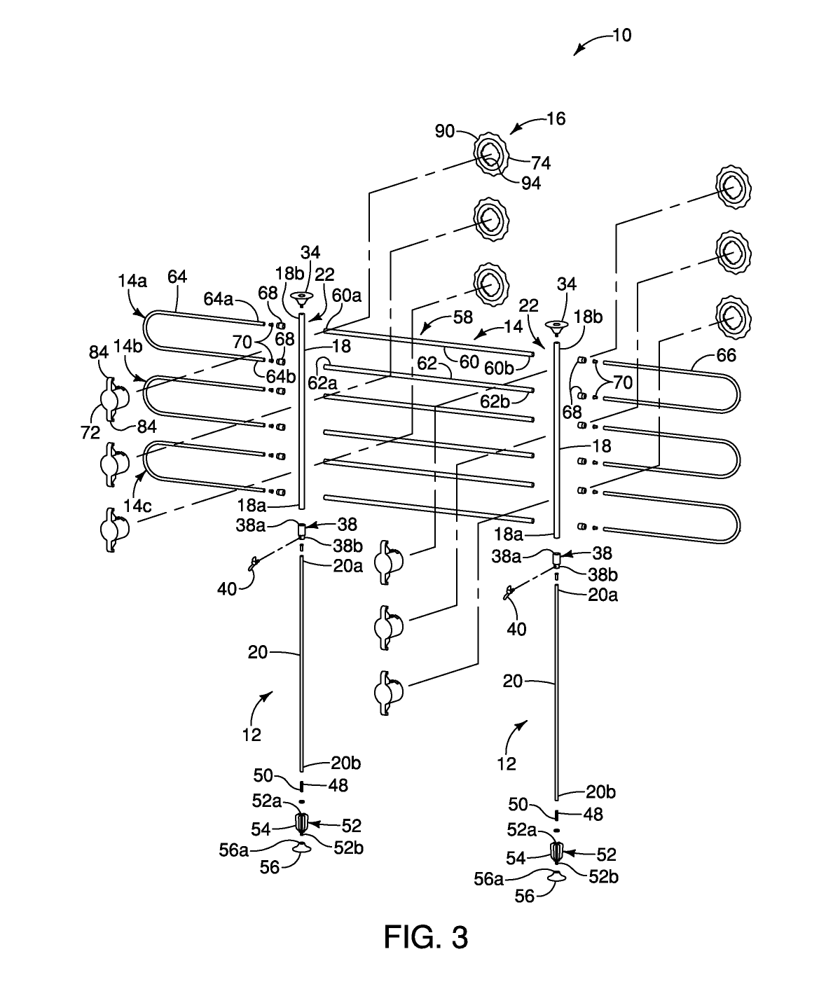

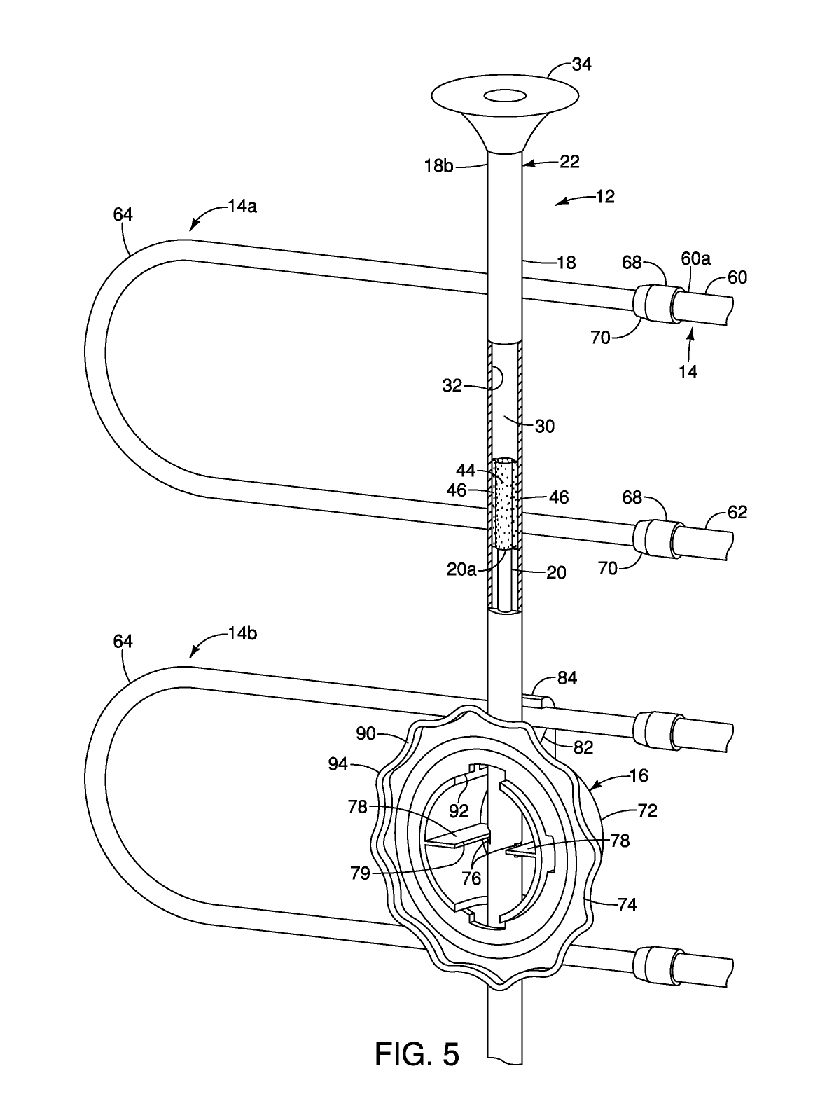

As best seen in FIG. 5, the first tube 18 of the telescoping tubes 12 has a hollow inner cavity 30 defined by an inner wall 32 that preferably extends the entire length of the first tube 18. The second tube 20 is sized and configured to be inserted into the inner cavity 30 of the first tube 18. Thus, the first tube 18 is an outer tube of the first support tube 22 and the second tube 20 is an inner tube. As seen in FIGS. 2 and 3, the first tube 18 has a first end 18a and a second end 18b. The first end 18a receives the second tube 20 into the inner cavity 30 of the first tube 18. The second end 18b of the first tube 18 is configured to receive a first bumper 34 in the inner cavity 30. Preferably, the first bumper 34 is a rubber friction cup having a substantially frustoconical shape that is configured to be detachably mounted to a vehicle wall (e.g., a vehicle ceiling). Thus, the first bumper 34 serves to secure the pet barrier 10 in place within the vehicle V.

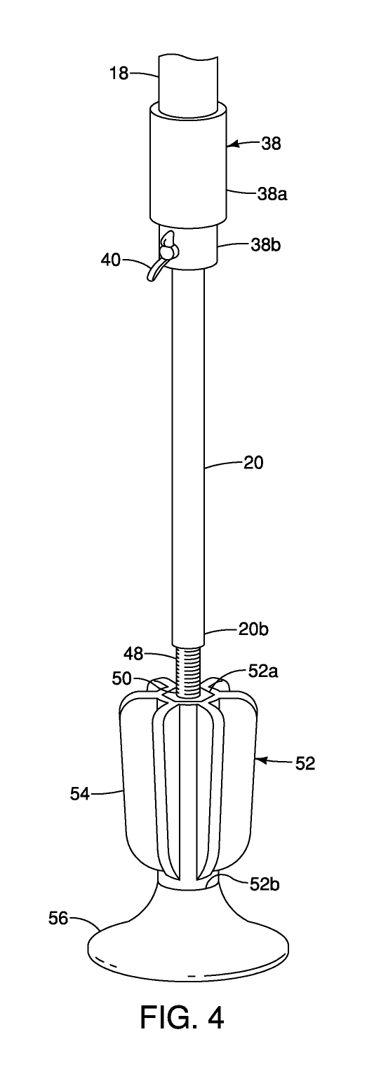

The first end 18a of the first tube 18 includes a receiving hole (not shown) sized and configured to receive the second tube 20 so as to enable at least a portion of the second tube 20 to be inserted into the inner cavity 30. The degree to which the second tube 20 is inserted into the inner cavity 30 of the first tube 18 can be adjusted by a first adjusting member 38, as shown in FIG. 4. In addition, the first adjusting member 38 secures the second tube 20 into the inner cavity 30 of the first tube 18. In the illustrated embodiment, the first adjusting member 38 has a first portion 38a and a second portion 38b. The first and second portions 38a and 38b are separated by an internal flange or abutment (not shown). The first portion 38a is sized and configured to receive the first end 18a of the first tube 18 so that the first end 18a abuts the internal flange of the first adjusting member 38. The second portion 38b has a smaller diameter than the first portion 38a and is configured to receive the second tube 20. The second tube 20 extends through the second portion 38b and the internal flange so that it can be inserted into the first end 18a of the first tube 18. The first adjusting member 38 has a threaded through hole (not shown) disposed on an external surface of the second portion 38b to receive a threaded wing bolt 40 therethrough. By loosening and tightening the wing bolt 40 into the threaded through hole (not shown), the degree to which the second tube 20 extends into the inner cavity 30 of the first tube 18 may be adjusted. Furthermore, by tightening the wing bolt 40, the second tube 20 is secured into the inner cavity 30 of the first tube 18. In other words, a receiving length of the first end section 20a of the second tube 20 within the first tube 18 is adjustable by the first adjusting member 38 via engagement of the wing bolt 40 and the threaded through hole. In this manner, the height of the first support tube 22 and the height of the pet barrier 10 is user adjustable.

The structure of the second tube 20 will now be further discussed. As shown in FIGS. 3 and 5, the second tube 20 has a first end section 20a and a second end section 20b. The first end section 20a is configured to be inserted into the inner cavity 30 of the first tube 18. As best seen in FIG. 5, the second tube 20 includes a noise damping cap 44 installed thereon to separate the second tube 20 from the inner wall 32 of the first tube 18. Specifically, the noise damping cap 44 is disposed on the first end section 20a of the second tube 20. The noise damping cap 44 is preferably preinstalled on the second tube 20. However, it will be apparent to those skilled in the art from this disclosure that the noise damping cap 44 may be provided as a separate member from the second tube 20 and configured to be installed thereon. Also, the noise damping cap 44 can be either fixedly installed on the second tube 20 or removably installed on the second tube 20, as desired. In the illustrated embodiment, the noise damping cap 44 is a tubular member having a receiving hole (not shown) that leads to an inner cavity (not shown) of the noise damping cap 44. The inner cavity of the noise damping cap 44 receives the first end section 20a of the second tube 20. In the illustrated embodiment, the noise damping cap 44 is secured to the first tube 18 by an external rib construction 46. In this capacity, the noise damping cap 44 includes at least one external rib 46 contacting the inner wall 32 first tube 18. Preferably, the noise damping cap 44 includes a pair of external ribs 46 disposed on an outer peripheral surface of the noise damping cap 44. As shown, the external ribs 46 are preferably a pair of flanges integrally formed with the noise damping cap 44 and are configured to contact the inner wall 32 of the first tube 18. In this manner, the noise damping cap frictionally contacts the inner wall 30 of the first tube 18.

In the illustrated embodiment, the noise damping cap 44 is configured to deform when the second tube 20 is inserted into the first tube 18. Thus, the noise damping cap 44 is constructed of a deformable or elastic type of material such that the noise damping cap 44 can be deformed when the first end section 20a of the second tube 20 is inserted into the inner cavity 30 of the first tube 18. In this manner, the noise damping cap 44 is secured in the first tube 18 by an interference fit. Preferably, in the illustrated embodiment, the noise damping cap 44 is constructed of a thermoplastic elastomer (TPE). The TPE material is preferably rated on the Shore A scale designating the optimal degree of hardness so that the noise damping cap 44 can easily slide into the first tube 18 while also being firmly disposed inside the first tube 18 to provide insulation that will dampen noise. In this manner, when the second tube 20 is inserted into the inner cavity 30 of the first tube 18, the second tube 20 does not touch the inner wall 32 of the first tube 18 due to the noise damping cap 44. As a result, during vehicle operation, the first and second tubes 18 and 20 are prevented from directly contacting each other. This construction prevents unwanted noise generated from irregular movements due to vehicle movement.

As best seen in FIG. 4, while the first end section 20a is secured inside the inner cavity 30 of the first tube 18, the second end section 20b of the second tube 20 is fixedly secured to a threaded rod 48. Preferably, the threaded rod 48 is permanently affixed to the second end section 20b by pinning, welding, crimping, riveting or any other suitable manner of attachment. The threaded rod 48 has a distal end section 50 that is received by a second adjusting member 52. Thus, the threaded rod 48 is received by the second adjusting member 52.

The second adjusting member 52 is configured to operatively engage the threaded rod 48 to adjust a length that the threaded rod 48 is received into the second adjusting member 52. In the illustrated embodiment, the second adjusting member 52 receives the threaded rod 48 into an inner cavity (not shown) at a first opening 52a of the second adjusting member 52. The first opening 52a of the second adjusting member 52 is threaded to operatively engage the distal end section 50 of the threaded rod 48 in order to adjust the degree to which the threaded rod 48 is received into the inner cavity 30 of the second adjusting member 52. In the illustrated embodiment, the second adjusting member 52 is a hand nut or a jumbo spinner. The second adjusting member 52 includes a plurality of holding surfaces 54 configured for gripping. Specifically, the second adjusting member 52 is configured for fine tension adjustment. That is, while the first and second adjusting members 38 and 52 are both configured to allow a user to adjust the relative height of the pet barrier 10, the first adjusting member 38 adjusts large variations in height while the second adjusting member 52 fine tunes the desired height of the pet barrier 10.

The second adjusting member 52 is configured to be inserted into a second bumper 56 at an end section 52b of the second adjusting member 52. In the illustrated embodiment, the second bumper 56 is configured to fixedly secure the first support tube 22 to another vehicle wall (e.g., a vehicle floor). The second bumper 56 is identical in structure and function to the first bumper 34. Thus, the second bumper 56 will not be further discussed herein.

Referring now to FIG. 6, the plurality of bars 14 will now be discussed. In the first illustrated embodiment, the plurality of bars 14 extends transverse to the telescoping tubes 12. As previously stated, the plurality of bars 14 is preferably made of a rigid material, such as metal or plastic. That is, the plurality of bars 14 extends transverse to the first and second support tubes 22 and 28. Also in the illustrated embodiment, the plurality of bars 14 includes a plurality of straight bars 60 and 62 that are each configured to be attached to one of a plurality of bended bars 64 and 66. As shown, the plurality of bars 14 preferably contains three sets of bars 14a, 14b and 14c extending in a transverse direction with respect to the first and second support tubes 22 and 28. It will be apparent to those skilled in the art from this disclosure that the pet barrier 10 may be configured with additional or fewer sets of transversely extending bars as desired. The plurality of bars 14 are arranged to serve as a partition structure between the pet containing area and the pet restricted area of the vehicle V. In the illustrated embodiment, the partitioning structure 58 includes two straight bars 60 and 62, each straight bar 60 and 62 being affixed to one of the bended bars 64 and 66. Thus, each set of transversely extending bars of the partitioning structure 58 includes two straight bars and two bended bars. However, it is noted that the plurality bars 14 can include as few or as many straight and bended bars, as desired. Also in the illustrated embodiment, the plurality of bars 14 is configured to be rigid members but may be arranged in any suitable configuration. As each set of bars of the partitioning structure 58 is identical in structure and function, only the first set 14a of the partitioning structure 58 will be discussed in this disclosure.

As shown, in FIGS. 1-3 and 6, the first set of the partitioning structure 58 includes a first straight bar 60 and a second straight bar 62. The first set further includes a first bended bar 64 and a second bended bar 66. The first and second straight bars 60 and 62 are identical and extend between the support tubes 22 of the telescoping tubes 12. Specifically, the first and second straight bars 60 and 62 extend between the first tubes 18. As best seen in FIG. 5, the first straight bar 60 has a first distal end 60a and a second distal end 60b. The first and second distal ends 60a and 60b of the first straight bar 60 are each configured to receive one of a first tube cap 68 (four shown in the Figures). In the illustrated embodiment, the first tube cap 68 is a hollow bone cap preferably constructed of rubber or another flexible material that can be deformed upon pressure. The first tube cap 68 is configured to be press fit or glued onto the first and second distal ends 60a and 60b of the first straight bar 60 such that the first and second distal ends 60a and 60b are received into a hollow opening (not shown) of the first tube cap 68. The first tube cap 68 has an inner flange or abutment (not shown) configured to abut the first distal end 60a or the second distal end 60b of the first straight bar 60. In this manner, the first tube cap 68 is securely fastened to the first and second distal ends 60a and 60b of the first straight bar 60. Similarly, the second straight bar 62 has first and second distal ends 62a and 62b each configured to receive additional ones of the first tube cap 68. The configuration of the second straight bar 62 and the first tube cap 68 is identical as that of the first straight bar 60 and will not be further discussed herein.

The first and second bended bars 64 and 66 are configured as U bend tubes. The first and second bended bars 64 and 66 each have a pair of ends, each end being configured to receive one of a second tube cap 70 (four shown in the Figures). As the first and second bended bars 64 and 66 are identical in function and construction, only the first bended bar 64 will be discussed herein. In the illustrated embodiment, the second tube cap 70 is constructed as a plastic tube cap and configured to be inserted into one of the receiving holes of a pair of ends 64a and 64b of the first bended bar 64. In the illustrated embodiment, the second tube cap 70 has a flange 70a which is a protrusion around a circumferential edge of the second tube cap 70. The flange 70a abuts the one of the first pair of ends 64a and 64b of the first bended bar 64 to secure the second tube cap 70 to the first and second distal ends 64a and 64b of the first bended bar 64.

The flange 70a of the second tube cap 70 is configured to engage an inner cavity (not shown) of the first tube cap 68. That is, the first bended bar 64 is inserted into the inner cavity of the hollow first tube cap 68 and is secured therein by the frictional force between the flange 70a of the second tube cap 70 and an inner wall of the first tube cap 68. In this manner, the first straight bar 60 is detachably connected to the first bended bar 64 via the attachment of the first tube cap 68 to the second tube cap 70. The attachment of all of the straight bars of the illustrated embodiment of the pet barrier 10 with the bended bars is identical and will not be further discussed for the sake of brevity.

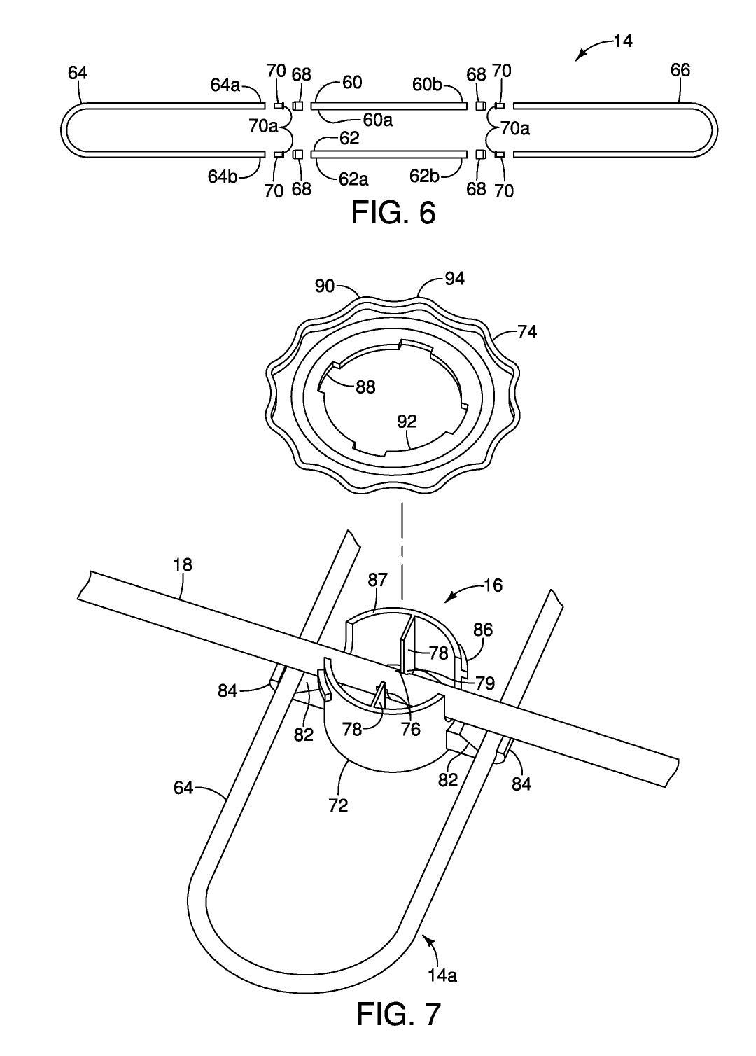

The locking device 16 will now be discussed in further detail with reference to FIG. 7. The locking device 16 is configured to secure the plurality of bars 14 to the telescoping tubes 12. As shown in the Figures, a total of six locking devices 16 are illustrated, each operatively situated to secure the plurality of bars 14 to one of the first tubes 18 of the telescoping tubes 12. It will be apparent to those skilled in the art that the pet barrier 10 can include as many or as few locking devices 16 as needed or desired. Specifically, in the first illustrated embodiment, the first and second bended bars 64 and 66 are secured to one of the first and third tubes 18 and 24 by the locking device 16. The locking device 16 includes a hub member 72 and a knob member 74 configured to operatively engage one another to secure the partitioning structure 58 to the support tubes 22 of the telescoping tubes 12. As all of the illustrated locking devices 16 are identical in structure and function, the discussion of the locking device 16 will be limited to a single locking device 16 and its connection to the support tube 22 and the first set of transversely extending bars 14a of the partitioning structure 58.

Preferably, the hub member 72 is constructed from a thermoplastic polymer such as ABS (acrylonitrile butadiene styrene). The hub member 72 may also be a rigid member such as a plastic or metal member or any other suitable material as needed and/or desired. The hub member 72 of the locking device 16 is configured to receive the first tube 18 of the support tube 22. The first tube 18 has a plurality of indents 76 etched on the outer surface of the first tube 18. In the illustrated embodiment, the plurality of indents 76 includes three pairs of indents (not shown) but it will be apparent to those skilled in the art that the first tube 18 may include additional or fewer indents to accommodate additional or fewer locking devices 16. As seen in FIGS. 5 and 7, the pair of indents 76 is configured to engage with a pair of flanges 78 of the hub member 72. The pair of flanges 78 of the hub member 72 form a receiving slot 79 therebetween sized and configured to receive the first tube 18. The locking device 16 is secured to the first tube 18 by engagement of the pair of flanges 78 with the pair of indents 76 of the first tube 18.

The hub member 72 further includes a pair of slots 82 disposed on a pair of protrusions 84 extending from a top and a bottom area of the hub member 72, or any other suitable surface. Each of the slots 82 is configured to receive one of the plurality of bars 14 which is secured therein by a press fit or interference fit. In the illustrated embodiment, as seen in FIG. 6, each of the slots 82 receives a straight portion of the first bended tube 64. However, it will be apparent to those skilled in the art from this disclosure that the locking device 16 can be rearranged on the partitioning structure 58 to receive one of the straight bars of the plurality of bars 14.

The hub member 72 further has a plurality of slanted and sloping flanges 86 arranged on a circumferential surface 87 of the hub member 72. The slanted and sloping flanges 86 are configured to operatively engage with corresponding slanted and sloping indentations 88 of the knob member 74. As shown, the knob member 74 has a substantially ring shaped structure with an outer circumferential edge 90 and an inner circumferential edge 92. The knob member 74 includes the corresponding slanted and sloping indentations 88 arranged at the inner circumferential edge 92 on an inside surface of the knob member 74 that faces the hub member 72. The outer circumferential edge 90 of the knob member 74 includes a plurality of gripping portions 94 so that a user can tighten or loosen the knob member 74 to the hub member 72. Similarly to the hub member 72, the knob member 74 is also preferably constructed of a thermoplastic polymer such as ABS (acrylonitrile butadiene styrene). The knob member 74 may also be made of another rigid type of material such as metal, if desired. In this manner, the knob member 74 secures the first tube 18 within the hub member 72. Also, in this way, the hub member 72 secures the first tube 18 to the plurality of bars 14.

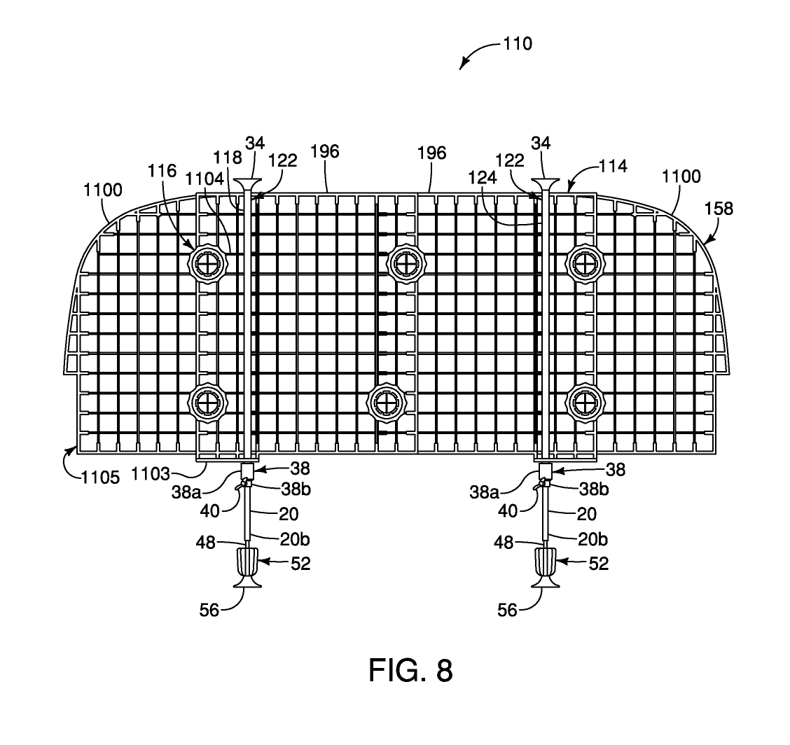

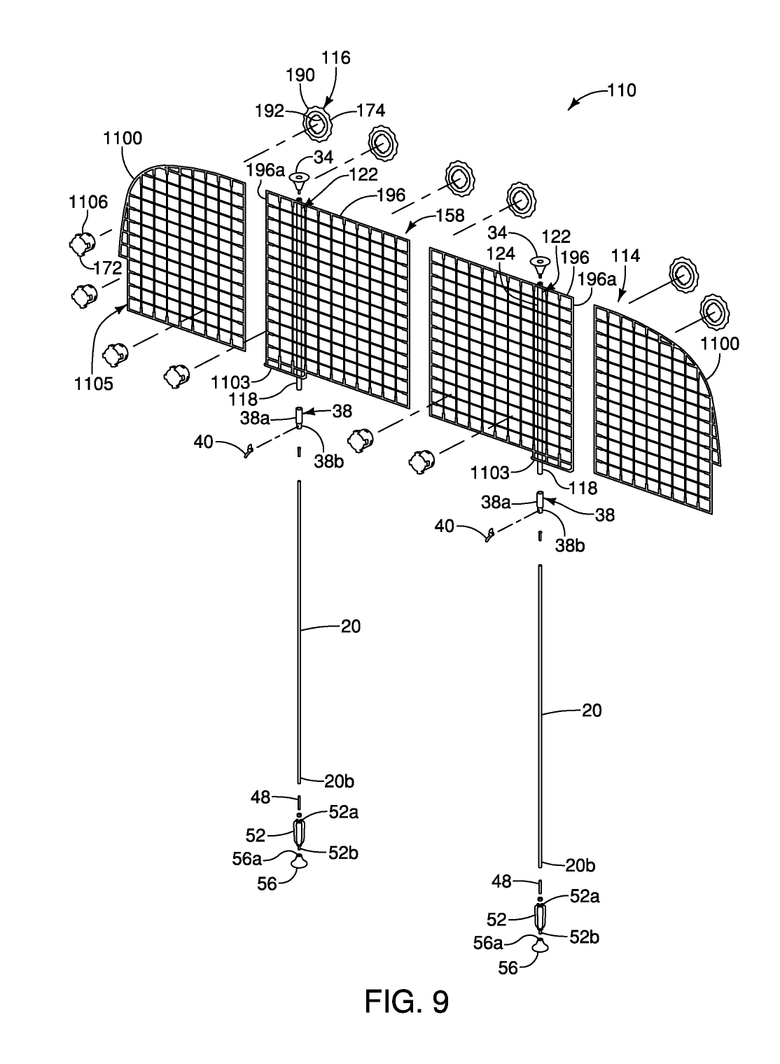

With reference now to FIGS. 8 to 12, a pet barrier 110 in accordance with a second illustrated embodiment will now be discussed. The pet barrier 110 is identical to the pet barrier 10 except that the plurality of bars 14 has been replaced with plurality of bars 114, the locking device 16 has been replaced with a locking device 116 and the first tube 18 has been replaced with a first tube 118. In the pet barrier 110 of the second illustrated embodiment, the plurality of bars 114 includes at least one wired grid. Preferably, the at least one wire grid includes a plurality of wire grids, the locking device 116 being configured to secure at least two wire grids together. Due to the similarity between the pet barriers 10 and 110, structures of the pet barrier 110 having identical corresponding structures in the pet barrier 10 will receive the same reference numeral, any modified structures of the pet barrier 110 will receive the same reference numeral as that of the corresponding structures in the pet barrier 10 but increased by 100.

In the second illustrated embodiment, the pet barrier 110 includes a support tube 122 having a first tube 118 and a second tube 20. The support tube 122 is secured to the inner walls of a vehicle (e.g., a vehicle ceiling or a vehicle floor) by bumpers 34 and 56 that are identical to the bumpers 34 and 56 of the first illustrated embodiment. The first tube 118 is constructed as an outer tube that is sized and configured to receive the second tube 20, constructed as an inner tube.

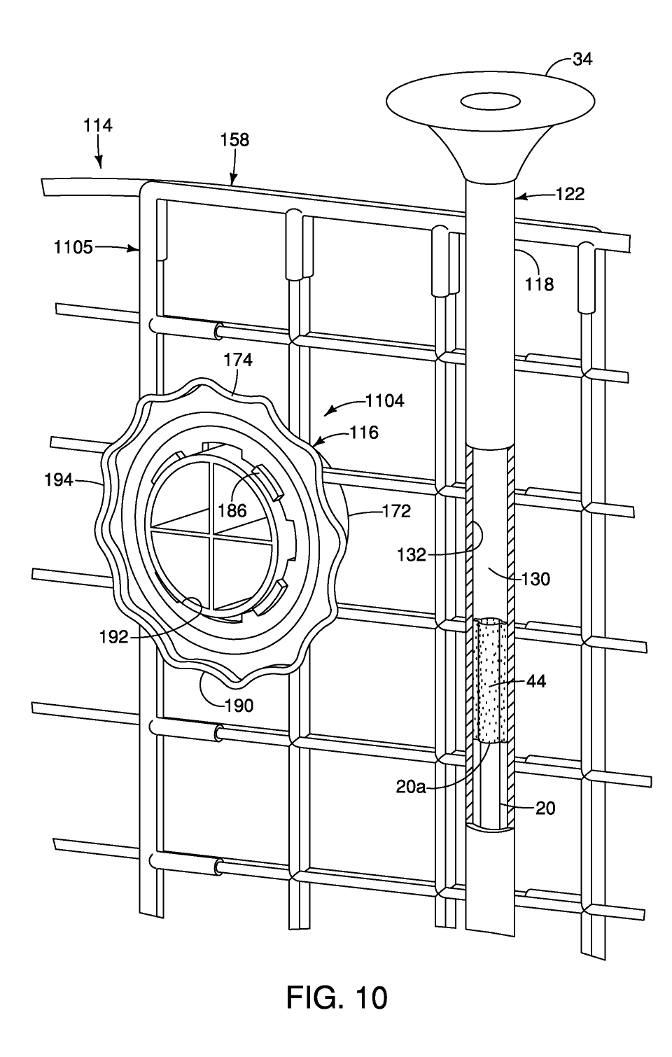

As seen in FIG. 10, the second tube 20 includes a noise damping cap 44 installed thereon at a first end section 20a of the second tube 20 that is inserted into an inner cavity 130 of the first tube 118. The noise damping cap 44 has the same structure and function as the noise damping cap 44 of the first illustrated embodiment and will not be further discussed herein. The second tube 20 further includes a second end section 20b attached to a threaded rod 48. The attachment mechanisms of the first tube 118 with the second tube 20 is identical to that in the first illustrated embodiment and will not be further discussed herein. Furthermore, the height of the first and second support tubes 122 and 128 are adjusted by first and second adjusting members 38 and 52 in the same manner as the first and second adjusting members 38 and 52 of the first illustrated embodiment, and will not be further discussed herein.

In the second illustrated embodiment, the plurality of bars 114 includes at least one wire grid unmovably secured to one of the first tube 118 and the third tube 124. As shown in FIG. 9, the at least one wire grid includes center grids 196 and side grids 1100. In the illustrated embodiment, the center grids 196 and the side grids 1100 are rigid members, preferably constructed of a low carbon mild steel or any other suitable material. However, it will be apparent to those skilled in the art that the at least one wire grid may be a bendable or flexible member such as a net. Together, the center grids 196 and the side grids 1100 form a partitioning structure 158 for the pet barrier 110. Each of the center grids 196 are identical in structure and function, except for their orientation on the pet barrier 110. Thus, any description of the center grids 196 will be in reference to a single center grid 196 in this disclosure. Similarly, each of the side grids 1100 identical in structure and function, except for their orientation on the pet barrier 110, description of the side grids 1100 will be in reference to a single side grid 1100 in this disclosure.

Assembly of the support tube 122 of the pet barrier 110 can comprise of the following steps: inserting the first end section 20a of the second tube 20 which has the noise damping cap 44 thereon into the inner cavity 130 at the second end 118b of the first tube 118; adjusting a receiving length of the second tube 120 inside the first tube 118 by tightening or loosening the wing bolt 40 of the first adjusting member 38; attaching the second end section 20b of the second tube 20 to the second adjusting member 52 by threading the threaded rod 48 into the threaded first opening 52a of the adjusting member 52; overlying a portion of one side grid 1100 over a portion of one center grid 196 so that a section of the side grid 1100 sits on a support protrusion 1103.

The center grid 196 is a substantially square grid having side edge portions 196a that are preferably lined with a soft or elastic member to smooth out sharp edges and to provide a finished look to the pet barrier 110. For example, the side edge portions 196a may be dipped in liquid rubber to create a rubber lining 1105 which lines the side edge portions of all of the plurality of grids. The rubber lining 1105 (depicted by the un-darkened wires in the Figures) also performs a noise damping function. Specifically, unwanted noise generated by the two grids contacting or rubbing against one another during road travel is ameliorated. As shown in FIGS. 8 and 9, the center grid 196 is spot-welded to the first tube 118. In addition, the spot-welded strength is preferably a minimum of 320 newton pull (72 LBF). In this manner, the first tube 118 is preferably preassembled to the center grid 196. However, it will be apparent to those skilled in the art from this disclosure that the center grid 196 may be fixedly installed onto the first tube 118 as needed and/or desired. As shown in the illustrated embodiment, the center grid 196 has a height substantially equal to the first tube 118.

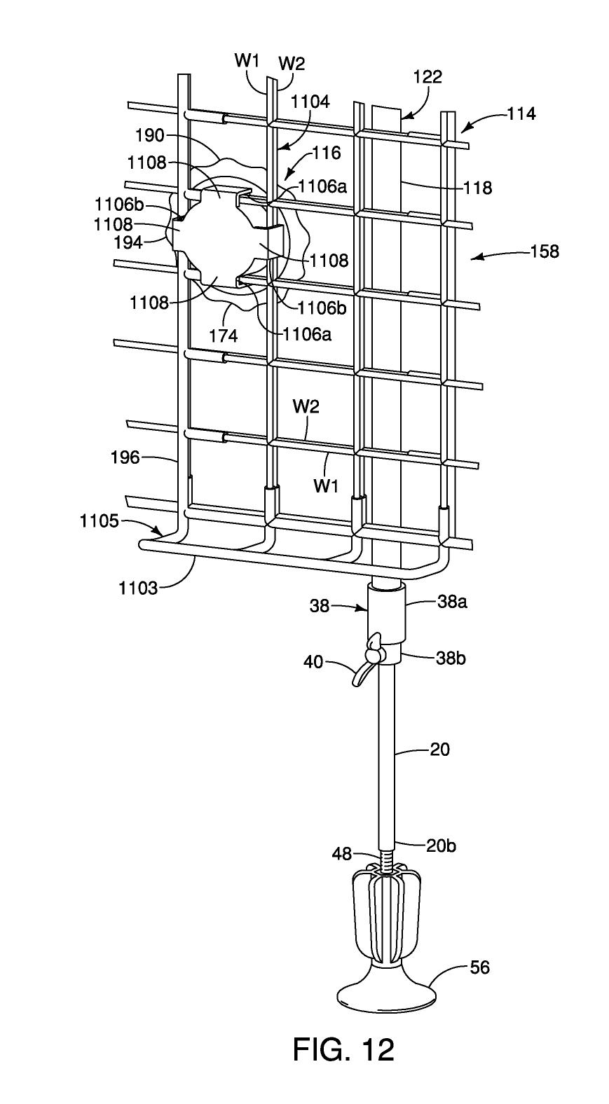

As best seen in FIGS. 9 and 12, the center grid 196 includes the support protrusion 1103 extending from the bottom portion and is configured to support the first side grid 1100 when the pet barrier 110 is in an assembled state. Thus, the support protrusion 1103 is preferably integrally formed with the center grid 196 and extends in a direction that is perpendicular to the plane of the center grid 196. In the illustrated embodiment, the first adjusting member 38 that interlocks the first tube 118 and the second tube 20 is disposed below the support protrusion 1103. This arrangement of the center grid 196, the support protrusion 1103 and the first tube 118 enables a sturdy partitioning structure 158. It will be apparent to those skilled in the art from this disclosure that the first tube 118 may be assembled to various locations on the center grid 196.

The side grid 1100 is configured to sit on the support protrusion 1103 of the center grid 196. In the illustrated embodiment, the side grid 1100 has a rounded side edge designed for a convenient fit inside the vehicle. Similar to the center grid 196, the first grid 1100 has side edge portions have the rubber lining 1105. Thus, the side edge portions of the side grid 1100 also has a noise damping lining.

The locking device 116 of the pet barrier 110 will now be discussed. As best seen in FIGS. 10 through 12, the locking device 116 is configured to interlock an overlapping region 1104 between the enter grid 196 and the side grid 1100. As shown, the pet barrier 110 includes a total of six locking devices 116 to secure the plurality of wire grids to one another. However, it will be apparent to those skilled in the art from this disclosure that the pet barrier 110 may be provided with more or fewer locking devices 116 to interlock more or fewer wire grids as desired. It will also be apparent to those skilled in the art from this disclosure that the overlapping region 1104 between that the center grid 196 and the side grid 1100 can be adjusted to be greater or smaller, thus the size of the partitioning structure 158 is adjustable.

The locking device 116 includes a hub member 172 and a knob member 174. The locking device 116 is basically identical to the locking device 16 of the first illustrated embodiment except that the hub member 172 has a plurality of receiving slots 1106 configured to receive at least one wire of the plurality of wire grids. As previously mentioned, the locking device 116 is configured to be installed on the overlapping region 1104 between the center grid 196 and the side grid 1100 to interlock the two grids. A portion of the hub member 172 is disposed in an open space between the wires of the overlapping region 1104 when the locking device 116 is installed.

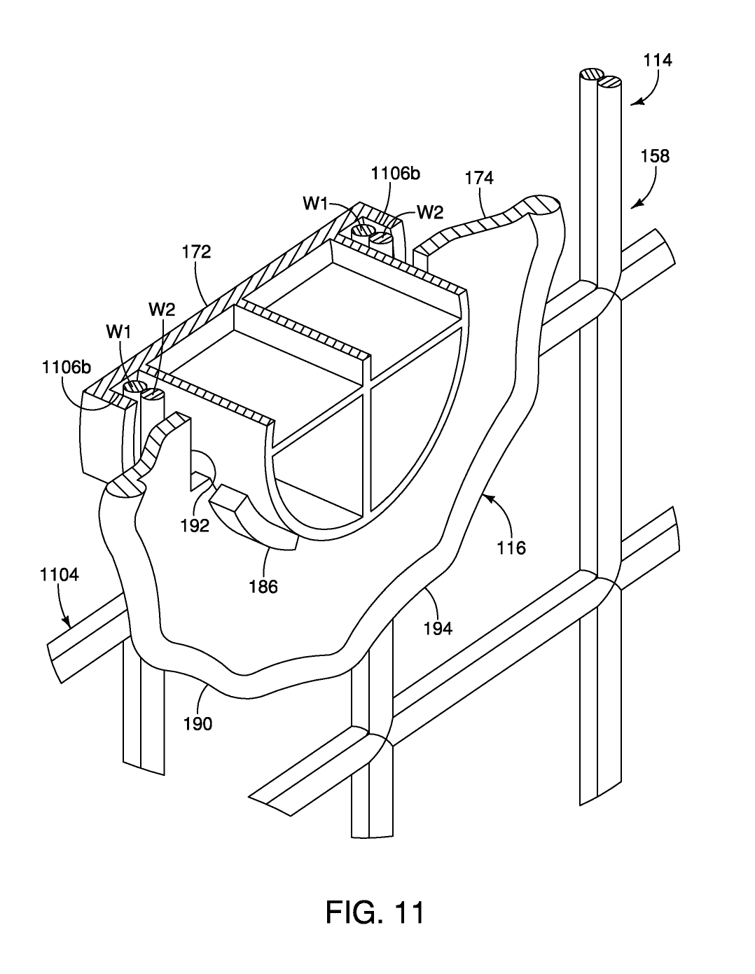

As best seen in FIGS. 11 and 12, the hub member 172 includes a pair of horizontal slots 1106a and a pair of vertical slots 1106b. The horizontal and vertical slots 1106a and 1106b are each disposed on one of the outwardly protruding flanges 1108 of the hub member 172. In the illustrated embodiment, each of the slots 1106a and 1106b is configured to receive two wires, a wire W1 of the first center grid 196 and a wire W2 of the side grid 1100. However, it will be apparent to those skilled in the art from this disclosure that the locking device 116 can be configured with additional or fewer receiving slots 1106 of different orientations to accommodate different types of wire grid configurations, as desired. Similar to the locking device 16 of the first illustrated embodiment, the locking device 116 is constructed of a bendable thermoplastic polymer such as ABS. The horizontal and vertical slots 1106a and 1106b are configured to receive the wires W1 and W2 of the plurality of grids by press fit, interference fit or snap fit.

In the illustrated embodiment, the hub member 172 can be installed on either an inside face or an outside face of the partitioning structure 158, as desired. To secure the hub member 172 to the plurality of wire grids, the knob member 174 is configured to be installed over the hub member 172 at the other of the inside face or the outside face that the hub member 172 is installed on. The knob member 174 includes an outer circumferential edge 190 and an inner circumferential edge 192. The inner circumferential edge 192 includes a plurality of slanted and sloping flanges (not shown) configured to engage a corresponding plurality of slanted and sloping indentations 186 disposed on the body of the hub member 172. The outer circumferential edge 190 of the knob member 174 includes gripping portions 194 for user contact. By tightening or loosening the knob member 174 to the hub member 172, the receiving slots 1106a and 1106b of the hub member 172 securely receive the wires of the plurality of grids by one of a press fit, interference fit and snap fit. Thus, the knob member 174 is configured to engage the hub member 172 such that operation of the knob member 174 to engage the hub member 172 enables the at least one wire to be fixedly received by the receiving slots 1106a and 1106b of the hub member 172. In the illustrated embodiment, the knob member 174 is configured to secure the wires to the hub member 172 by a quarter turn of the knob member 174.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional term “transverse” as well as any other similar directional terms refer to those directions of a pet barrier in an upright, installed position. Accordingly, these directional terms, as utilized to describe the pet barrier should be interpreted relative to a pet barrier in an upright, installed position.

Also it will be understood that although the terms “first” and “second” may be used herein to describe various components these components should not be limited by these terms. These terms are only used to distinguish one component from another. Thus, for example, a first component discussed above could be termed a second component and vice-a-versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet barrier comprising:
a plurality of telescoping tubes configured to be disposed in a vehicle, the telescoping tubes including a first tube and a second tube, the second tube being sized and configured to be inserted into an inner cavity of the first tube, the second tube including a noise damping cap disposed thereon to separate the second tube from an inner wall of the first tube,
a plurality of bars extending transverse to the telescoping tubes;
at least one locking device configured to secure the plurality of bars to the telescoping tubes.

2. The pet barrier according to claim 1, wherein
the noise damping cap includes at least one external rib contacting the inner wall first tube.

3. The pet barrier according to claim 1, wherein
the noise damping cap is configured to deform when the second tube is inserted into the first tube.

4. The pet barrier according to claim 1, wherein
the noise damping cap is formed from a thermoplastic elastomer.

5. The pet barrier according to claim 1, wherein
the second tube has a first end section and a second end section, the first end section being configured to be inserted into the inner cavity of the first tube, a receiving length of the first end section within the inner cavity being adjustable by a first adjusting member.

6. The pet barrier according to claim 5, wherein
the noise damping cap is disposed on the first end section of the second tube.

7. The pet barrier according to claim 5, wherein
the second end section of the second tube is fixedly secured to a threaded rod.

8. The pet barrier according to claim 7, wherein
the threaded rod is received by a second adjusting member, the second adjusting member being configured to operatively engage the threaded rod to adjust a length that the threaded rod is received into the second adjusting member.

9. The pet barrier according to claim 1, wherein
the locking device includes a hub member and a knob member, the hub member being configured to receive the first tube, the knob member configured to engage the hub member to secure the first tube within the hub member.

10. The pet barrier according to claim 1, wherein
the telescoping tubes further includes a third tube and a fourth tube, the third tube being identical to the first tube and the fourth tube being identical to the second tube.

11. The pet barrier according to claim 10, wherein
the plurality of bars includes a plurality of straight bars that are each configured to be attached to one of a plurality of bended bars, the plurality of bars being secured to one of the first and third tubes by the locking device.

12. The pet barrier according to claim 1, wherein
the plurality of bars includes at least one wire grid.

13. The pet barrier according to claim 11, wherein
the plurality of bars includes at least one wire grid unmovably secured to one of the first and third tubes.

13. The pet barrier according to claim 12, wherein
the at least one wire grid includes a plurality of wire grids, the locking device being configured to secure a first wire grid to a second wire grid.

14. The pet barrier according to claim 13, wherein
the locking device includes a hub member and a knob member, the hub member having a plurality of receiving slots configured to receive at least one wire of the plurality of wire grids.

15. The pet barrier according to claim 14, wherein
the knob member is configured to engage the hub member such that operation of the knob member to engage the hub member enables the at least one wire to be fixedly received by the receiving slots of the hub member.

16. The pet barrier according to claim 2, wherein
the noise damping cap includes a pair of external ribs configured as laterally protruding flanges contacting the inner wall of the first tube.

17. The pet barrier according to claim 1, wherein
the noise damping cap is fixedly installed on the second tube.

18. The pet barrier according to claim 1, wherein
the noise damping cap is removably installed on the second tube.

19. The pet barrier according to claim 1, wherein
the noise damping cap is configured to frictionally contact the inner wall of the first tube.

20. A method of assembling a pet barrier, comprising:
inserting an inner telescoping tube having a noise damping cap installed at an end section of the inner tube into an inner cavity of an outer telescoping tube to form a support structure;
intersecting a partition structure over an area of the support structure; and
attaching the partition structure to the support structure by engaging a hub member at one planar side of the partition structure with a knob member at another planar side of the partition structure.
